(19) United States
(12) Patent Application Publication
(10) Pub. No.: US 2013/0146654 A1
(43) Pub. Date: Jun. 13, 2013

(54) FIREWORKS INFORMATION SYSTEMS AND METHODS

(71) Applicants: RICHARD EMMETT FEINER, III, ATLANTA, GA (US); RICHARD EMMETT FEINER, II, Jackson, MO (US)

(72) Inventors: RICHARD EMMETT FEINER, III, ATLANTA, GA (US); RICHARD EMMETT FEINER, II, Jackson, MO (US)

(21) Appl. No.: 13/710,056

(22) Filed: Dec. 10, 2012

Related U.S. Application Data
(60) Provisional application No. 61/569,241, filed on Dec. 10, 2011.

(51) Int. Cl. G06F 17/30

(52) U.S. Cl. CPC G06F 17/30002; G06F 17/30781
USPC 235/375

(57) ABSTRACT

Firework information systems, according to various embodiments, are configured to receive a request to view information associated with a particular firework. In response to the request, the system may be configured to retrieve information associated with the particular firework including video images of the firework being fired. The system may be further configured to display the information to a user. In a particular embodiment, the system is configured to allow a user to scan a barcode, such as a UPC code, on firework packaging. In response to receiving the barcode scan, the system may be configured to retrieve information associated with the firework, such as video of the firework being fired, and display the information to the user.

### CROSS REFERENCE TO RELATED APPLICATION

This application claims the benefit of U.S. Provisional Application No. 61/569,241, entitled Firework Information Systems and Methods, filed Dec. 10, 2011, which is hereby incorporated herein in its entirety.

### BACKGROUND OF THE INVENTION

Consumers of fireworks often lack relevant product information while shopping for fireworks in retail locations. Many firework retailers spend a considerable amount of money training their sales staff to relay this product information. Currently, there is a need for improved methods of providing firework information to potential customers and others.

### SUMMARY OF THE INVENTION

Computer systems, according to various embodiments, comprise at least one processor. In various embodiments, the computer system may be configured for reading one or more machine-readable indicia associated with one or more fireworks. The machine-readable indicia may represent, for example, a UPC code associated with the one or more fireworks. At least partially in response to reading the one or more machine-readable indicia, the computer system may be configured to retrieve (e.g., in a substantially automatic and immediate manner) information associated with the one or more fireworks where the information includes one or more video images of the one or more fireworks. The system may then display the information to the user.

A computer-implemented method of displaying firework information to a user comprises: (1) facilitating the reading of a UPC code associated with a particular firework; (2) after facilitating the reading of the UPC code, determining, by a computer processor, the UPC code; (3) using, by a computer processor, the UPC code to access video of the particular firework detonating; and (3) displaying the video to the user on a computer display. In particular embodiments, the method includes displaying the video substantially immediately in response to the UPC code being read by a user.

A computer-readable medium storing computer-executable instructions for: (1) facilitating the reading of a barcode representing a UPC code associated with a particular firework; (2) after facilitating the reading of the barcode, determining, by a computer processor, the UPC code; (3) after determining the UPC code, accessing video of the particular firework detonating; and (4) displaying the video to the user on a computer display.

### BRIEF DESCRIPTION OF THE DRAWINGS

Having described various embodiments in general terms, reference will now be made to the accompanying drawings, which are not necessarily drawn to scale, and wherein:

FIG. 1 shows a block diagram of a Fireworks Information System according to a particular embodiment;

FIG. 2 shows a schematic diagram of a computer, such as the Fireworks Information Server of FIG. 1, that is suitable for use in various embodiments;

FIG. 3 shows a flow chart that generally illustrates various steps executed by a Fireworks Information Module that, for example, may be executed by the Fireworks Information Server of FIG. 1;

FIGS. 4-6 show screen displays generated by a Fireworks Information System according to particular embodiments.

### DETAILED DESCRIPTION

Various embodiments will now be described more fully hereinafter with reference to the accompanying drawings, in which various relevant embodiments are shown. The invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

Fireworks information computer systems, according to particular embodiments, may be configured to provide a user with the ability to view information about certain consumer-grade fireworks (or other types of fireworks) and to browse/search for fireworks based on certain firework attributes. The computer system may include, for example, any suitable computing device (e.g., a desktop computer, a computerized kiosk, a mobile computing device such as a cellular phone or tablet computer, a laptop computer, or any other suitable computing device). A user may utilize the system to input firework identifying information (e.g., via a bar code scanner, a computer keyboard, or other input device associated with the system). The system then retrieves and displays information about the firework for which the identifying data was entered.

In various embodiments, in response to identifying data for the firework being entered into the system, the system may first display video of the firework detonating and then display other information about the firework such as ratings and reviews of the firework, images of the firework's packaging, and attributes that suggest whether or not the firework is safe. The system may also make suggestions about other fireworks a user might like. The suggestions may be based, for example, on the user's interest (e.g., perceived interest) in the firework for which the user has requested information, or other factors, such as the user's purchase history or the user's ratings of other fireworks.

For example, if a user enters identifying data for a small cone fountain, the system may provide suggestions from the program for other small cone fountains or fireworks that have similar effects and attributes and/or effects and attributes that the user has rated positively in the past. The system may also provide information regarding other fireworks that remain stationary when in use (since the cone fountain remains stationary when in use). The system may be further configured to allow a distributor or retailer to specify certain fireworks for special promotion. The system may present coupons to the user based on this information or it may provide targeted marketing (e.g., recommending fireworks similar to the firework for which the user has requested information that a manufacturer or distributer strongly desires to sell).

The system may be configured to communicate firework data between networked computers (e.g., via the Internet). For example, the system may be adapted to send and receive business intelligence information between networked computers. Such business intelligence information may include sales information for a particular firework including sales volume and pricing. The system may be further adapted to substantially automatically (e.g., automatically) update the system's database (e.g., local database) of firework information from firework information available via the Internet.

### Exemplary Technical Platforms

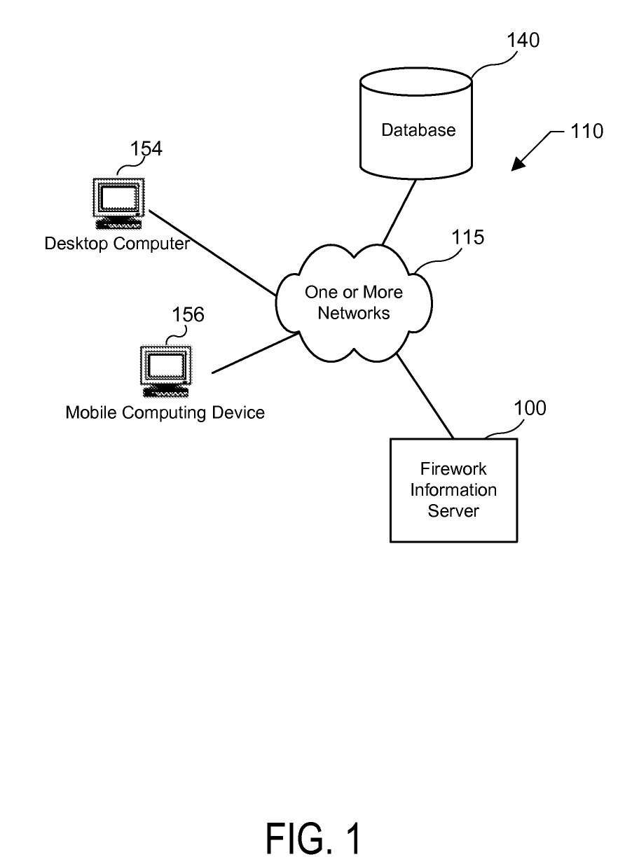

FIG. 1 is a block diagram of a Firework Information System 110 according to a particular embodiment. As may be understood from this figure, the Firework Information System 110 includes one or more computer networks 115, a Firework Information Server 100, a Database 140, and one or more remote computing devices such as a desktop computer 154, or a mobile computing device 156, such as a cellular phone, tablet computer, or other handheld computing device. In particular embodiments, the one or more computer networks facilitate communication between the Firework Information Server 100, database 140, and one or more remote computing devices 154, 156.

The one or more computer networks 115 may include any of a variety of types of wired or wireless computer networks such as the Internet, a private intranet, a public switch telephone network (PSTN), or any other type of network. The communication link between the Firework Information Server 100 and database 140 may be, for example, implemented via a Local Area Network (LAN) or via the Internet.

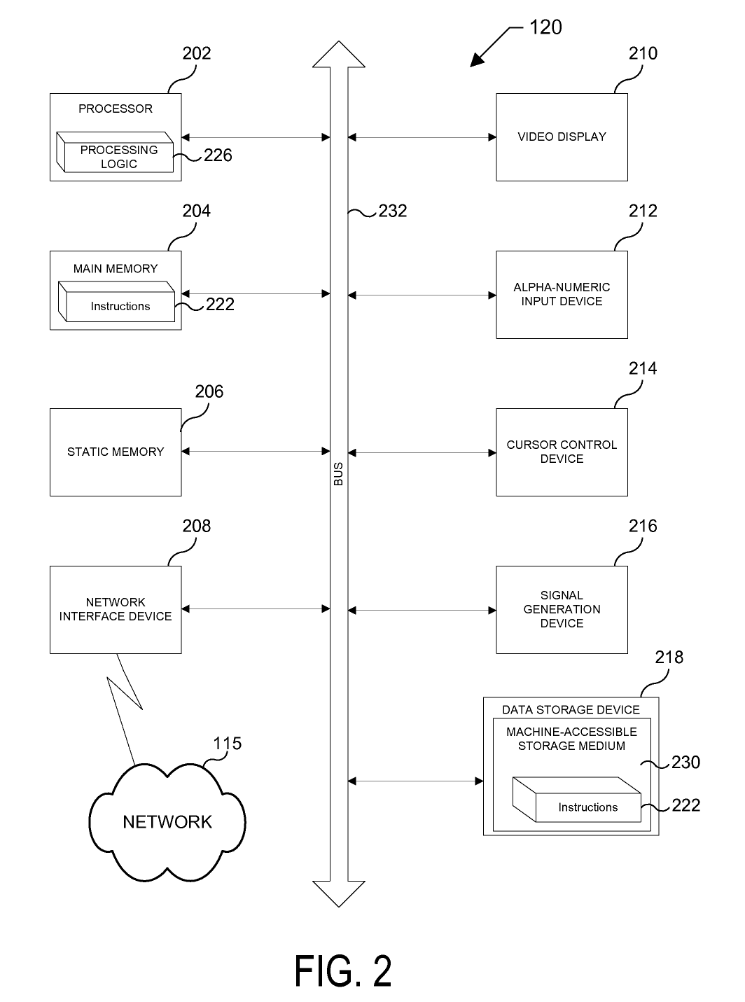

FIG. 2 illustrates a diagrammatic representation of a computer 120 that can be used within the Firework Information System 110, for example, as a client computer (e.g., one of client computers 154, 156 shown in FIG. 1), or as a server computer (e.g., Firework Information Server 100 shown in FIG. 1). In particular embodiments, the computer 120 may be connected (e.g., networked) to other computers in a LAN, an intranet, an extranet, and/or the Internet. As noted above, the computer 120 may operate in the capacity of a server or a client computer in a client-server network environment, or as a peer computer in a peer-to-peer (or distributed) network environment. The Computer 120 may be a personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

In various embodiments, the computer 120 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 120 may further include a network interface device 208. The computer 120 also may include a video display unit 210 (e.g., a liquid crystal display (LCD) or a cathode ray tube (CRT)), an alphanumeric input device 212 or other input device (e.g., a keyboard or other input device, such as a bar code scanner), a cursor control device 214 (e.g., a mouse), and a signal generation device 216 (e.g., a speaker).

The data storage device 218 may include a non-transitory computer-accessible storage medium 230 (also known as a non-transitory computer-readable storage medium or a non-transitory computer-readable medium) on which is stored one or more sets of instructions 222 (e.g., software) embodying any one or more of the methodologies or functions described herein. The instructions 222 may also reside, completely or at least partially, within main memory 204 and/or within processing device 202 during execution thereof by computer 120. The software 222 may further be transmitted or received over a network 220 via network interface device 208.

While the computer-accessible storage medium 230 (also referred herein to as a computer-readable medium) is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium that is capable of storing, encoding or carrying a set of instructions for execution by the computer and that cause the computer to perform any one or more of the methodologies of the present invention. The terms “computer-accessible storage medium” and “computer-readable medium” should accordingly be understood to include, but not be limited to, solid-state memories, optical and magnetic media, etc.

### Exemplary System Platform

Various embodiments of a system for providing firework information are described below. Various aspects of the system's functionality may be executed by certain system modules, including a Firework Information Module 300. This module is discussed in greater detail below.

Exemplary Firework Information Module

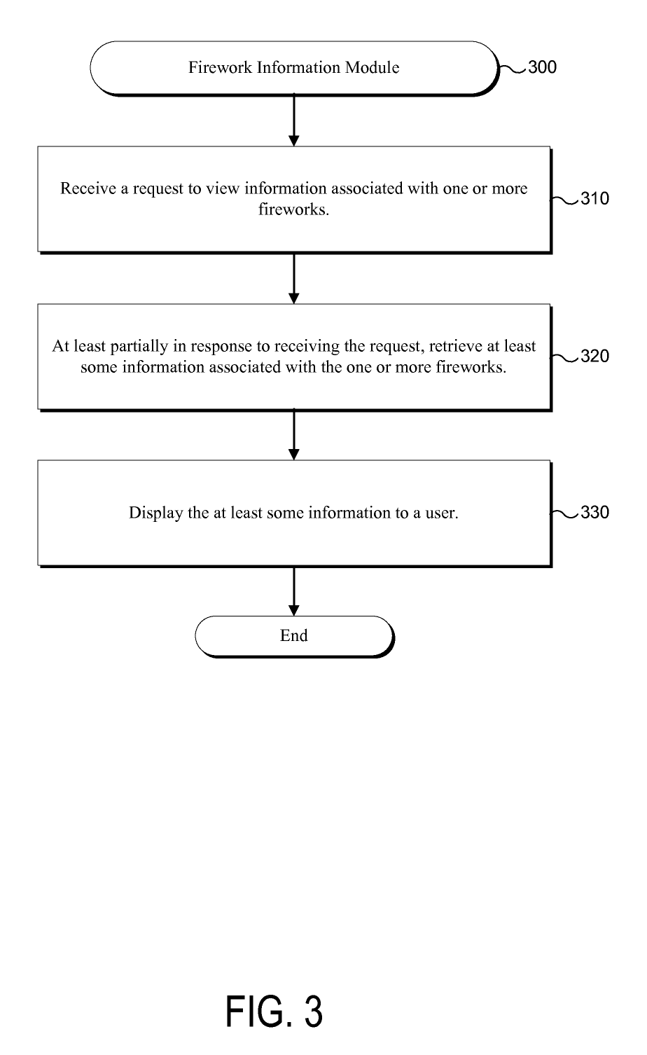

FIG. 3 shows a flow chart of operations performed by an exemplary Fireworks Module Information Module 300. In particular embodiments, the Fireworks Module Information Module 300 may facilitate the retrieval and display of information associated with particular firework models.

When executed by the system, the Firework Information Module begins at Step 310 by receiving a request to view information associated with one or more fireworks. In particular embodiments, the system is adapted to understand certain types of user inputs as requests to receive information with one or more fireworks. For example, the system may be configured so that, if a user uses a bar code scanner associated with the system to scan the UPC code of a particular firework, the system understands the scanning as being a request to view information associated with the particular firework. The system may also be adapted to understand an input of certain alphanumeric information to be a request to view information regarding a particular type of firework associated with the alphanumeric information. For example, if a user enters alphanumeric information that corresponds to the UPC code of a particular model of firework, the system may understand this as being a request to view information regarding the model of firework.

In particular embodiments, the system may understand, for example, any of the following to be a request to receive information regarding a particular model of firework: (1) a user using a bar code reader or other reader to scan a machine readable indicium (e.g., or a plurality of machine readable indicia) associated with a particular firework (e.g., a linear or matrix bar code located on the particular firework's packaging); (2) a user using a digital camera (e.g., a camera associated with a mobile device) to take an image of one or more machine-readable indicia associated with a particular firework—in which case the system may use suitable techniques to read the barcode within the picture; or (3) a user inputting, into the system, alphanumeric information that corresponds to a particular model of firework (e.g., by entering the information via a keyboard or by taking a picture of alphanumeric information associated with the particular firework so that the system can use optical character recognition techniques to read the alphanumeric information). In various embodiments, the machine-readable indicia associated with the particular firework may include any suitable machine-readable indicia, such as a linear barcode (e.g., the barcode that corresponds to the UPC code for the particular model of firework, or other linear barcode), a matrix barcode such as a QR code that corresponds to the particular model of firework, or any other suitable machine-readable indicia.

The system continues, at Step 320, by, at least partially in response to receiving the request, retrieving at least some information associated with the one or more fireworks. This information may include, for example: (1) a type of the one or more fireworks (e.g., such as bottle rockets, roman candles, flares, ground spinners, multi-shot aerial devices or cakes, sparklers, Catherine Wheels, etc.); (2) a model type that corresponds to the one or more fireworks; (3) one or more video images of the one or more fireworks being detonated; (4) information relating to the noise level, customer ratings, price, safety, colors, or effects of the one or more fireworks; (5) discounts or coupons available for the one or more fireworks; or (6) any other suitable firework information.

In various embodiments, firework information may include the names of one or more fireworks that are similar to the one or more fireworks for which information was requested. For example, the system may be configured to retrieve information about a firework (other than the one or more fireworks for which information was requested) that shares at least one attribute with the one or more fireworks for which information was requested (e.g., a firework that is of the same general type, or a firework with a similar noise level, color, effects, safety rating, etc.). In particular embodiments, the system may be configured to display information about these related fireworks and refer them to the requestor as fireworks in which the requester may be interested (e.g., due to the requestor's interest in the firework for which the requestor has requested information).

Next, at Step 330, the system displays the information retrieved at Step 320. In various embodiments, the system is configured to display (or otherwise communicate) the information to the user from which the system received the request. The system, in particular embodiments, may be configured to display the information to the user on any suitable display device (e.g., a monitor associated with a retail firework kiosk, a display screen associated with a mobile device such as a smartphone or tablet computer, or any other suitable display capable of displaying the firework information). This may include, for example, displaying a video of the firing of the one or more fireworks or otherwise enabling a user to view the video (e.g., by selecting or clicking on a display element (e.g., a URL) associated with a video of the firework).

Exemplary Embodiment of Firework Information Software—Retail Kiosk

A particular embodiment of the firework information system comprises a computer running suitable software (e.g., a computer within a kiosk), and a barcode scanner. When a user scans a firework's barcode with the barcode scanner, the system queries the database for the relevant firework information and then plays a video clip that represents the performance of the firework that was scanned. Other information about the firework may also be displayed (e.g., such as brand, type, noise level, safety, altitude, colors, effects, firework type, etc.).

In response to the barcode being scanned, the system may suggest other recommended fireworks to the consumer by displaying them on the computer's user interface. The system may do this by analyzing similarities between the firework that was scanned (e.g., that presumably interests the consumer) and other fireworks in the database. The logic for suggesting fireworks may take many different parameters into account. Some of the parameters may include, for example, noise level, safety, altitude, colors, effects, firework type, or any other suitable parameter for determining firework similarity.

The system may also allow users to search for fireworks based on certain attributes such as noise level, safety, altitude, colors, effects, and firework type. The system may provide the user with an interactive user interface that allows the user to search for firework products by indicating the characteristics of the firework that are important to the user.

The system may be capable of displaying other user-provided content associated with the firework product. This information may include user reviews, social networking data, users' favorite fireworks, wish lists, and other related media. The system may present the user with marketing materials and coupons based on a manufacturer's, distributer's, or retailer's preferences stored in the database.

The system described above may, for example, be included within a kiosk located within a retail store that sells fireworks. Customers may use the kiosk to decide which fireworks to purchase based on information retrieved from the kiosks (e.g., information regarding the appearance of the firework in use). The system, in such an embodiment, may be configured to track kiosk use information for review by a merchant or retailer that has made the kiosk available for customers, and/or the manufacturer of one or more fireworks. For example, a kiosk placed in a particular fireworks store may record information about which fireworks customers frequently scan for information (e.g., based on the brand of the firework, type, or based on any other attribute associated with the firework). The merchant or retailer may user this information for any suitable reason such as, for example: (1) determining what varieties and brands of fireworks are more or less popular (e.g., for the purpose of making future purchase orders, or offering special deals on fireworks that may otherwise not garner very much customer interest); or (2) implementing marketing directives for particular fireworks that the retailer may wish to sell more of or create more interest in.

Exemplary Embodiment of Firework Information Software—Mobile Application

Another embodiment of a firework information system may include a mobile application for use with a mobile device, such as a smart phone, tablet computer, etc. In various embodiments, the system may be configured to allow users to download firework information applications directly to a computing device (e.g., a mobile computing device or desktop computer) associated with the user. The applications may enable the user to retrieve firework information using their own computing device. For example, a user may download a firework information application to the user's smart phone (e.g., iPhone, Android phone, etc.) and utilize the smart phone to access firework information about a firework in which the user may be interested.

If a user is shopping for fireworks, the user may utilize the smart phone to image or otherwise scan any suitable indicia on the firework (e.g., on the firework's packaging). For example, the user may utilize a built-in camera associated with the smartphone to image a barcode on the firework's packaging, to image the firework's packaging itself, or any other suitable identifying mark associated with the firework. The system may then receive the image (e.g., via the firework information application) and retrieve information associated with the firework based on the recognized indicia or other identifying feature within the image. For example, in particular embodiments, the system may be configured to utilize optical character recognition (OCR) techniques to read identifying information from an image of the firework's packaging (e.g., such as the name, brand, model number, etc. of the firework). In other embodiments, the system may be configured to identify one or more machine-readable indicia in the image (e.g., a barcode, QR code, or similar indicia). The system may be configured to identify the firework for which the user is requesting information based at least in part on the identifying information (e.g., the name of the firework, the machine-readable indicia, etc.) The system may then retrieve the information associated with the firework based at least in part on the identifying information (e.g., by accessing a suitable database) and display it to the user on a display screen associated with the user's smartphone or other mobile device.

### Exemplary User Experience

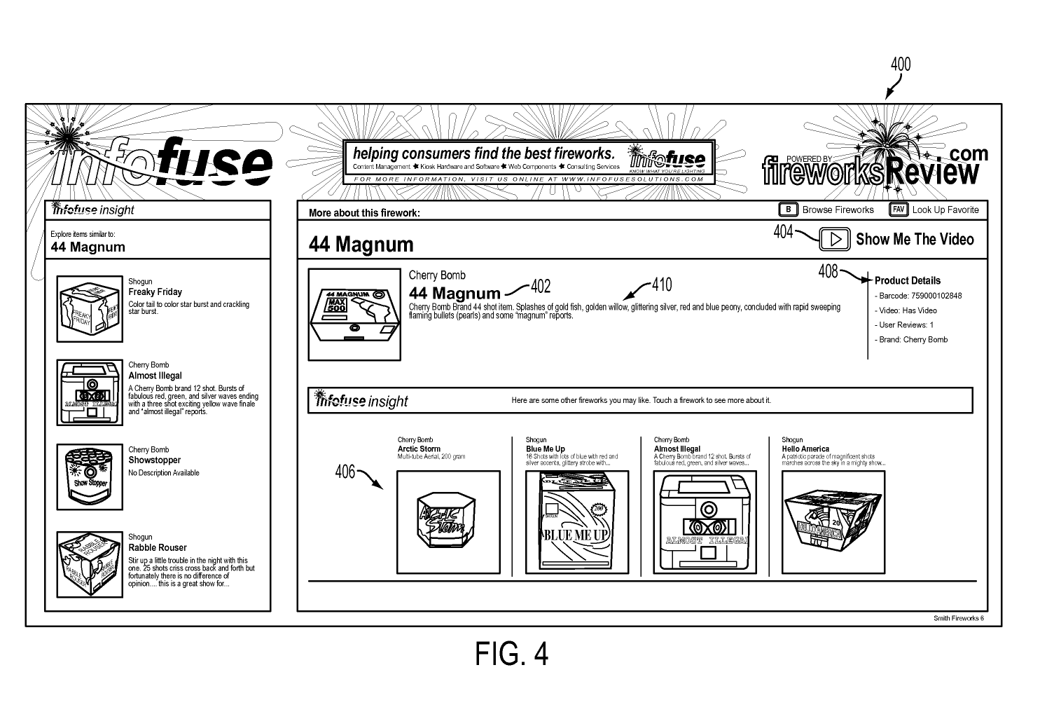

An exemplary user interface for a particular embodiment of a Firework Information System is shown in FIG. 4. This figure represents an interface that may be displayed on a tablet computer, desktop computer, laptop computer, handheld device such as a smart phone, and other similar computing devices. These interfaces show what a user may experience, for example, when accessing the system.

FIG. 4 shows an exemplary firework information display 400. In the exemplary interface shown in this figure, the system displays information about a particular model firework 402 (e.g., a 44 Magnum firework). In various embodiments, the system may have displayed information about this particular firework 402 at least partially in response to receiving a request for information from a user (e.g., at least partially in response to a user scanning a barcode located on packaging for the particular firework). As shown in this figure, the firework information display 400 includes a description 410 of the particular firework 402 (e.g., a description of the colors, performance, etc. of the firework). The firework information display 400 also includes a display element 404 that may be selectable to initiate the display, on the system's display, of a video of the firework being fired and/or detonated.

In the embodiment shown in this figure, the firework information display 400 includes additional product details 408 such as the brand of the firework (e.g., Cherry Bomb). The firework information display 400, according to this embodiment, also includes related fireworks 406, which may, for example, include other fireworks in which the user may be interested (e.g., based on their interest in the particular firework 402, or other factors, such as those described above.)

### Exemplary Firework Merchant Experience

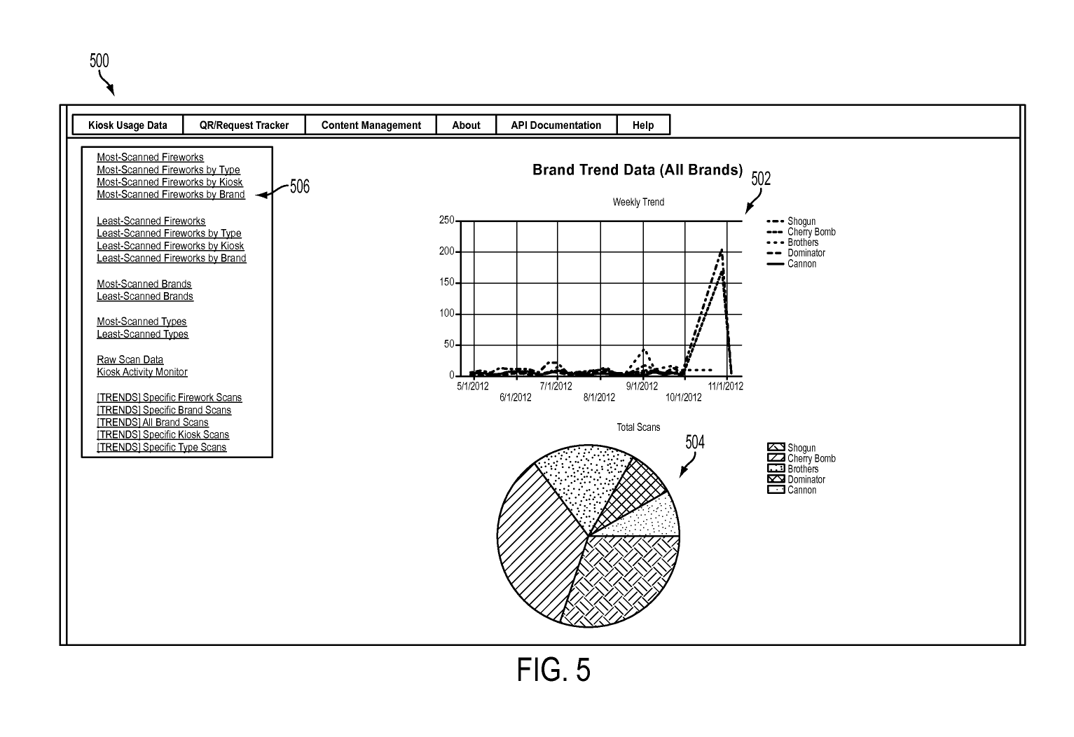

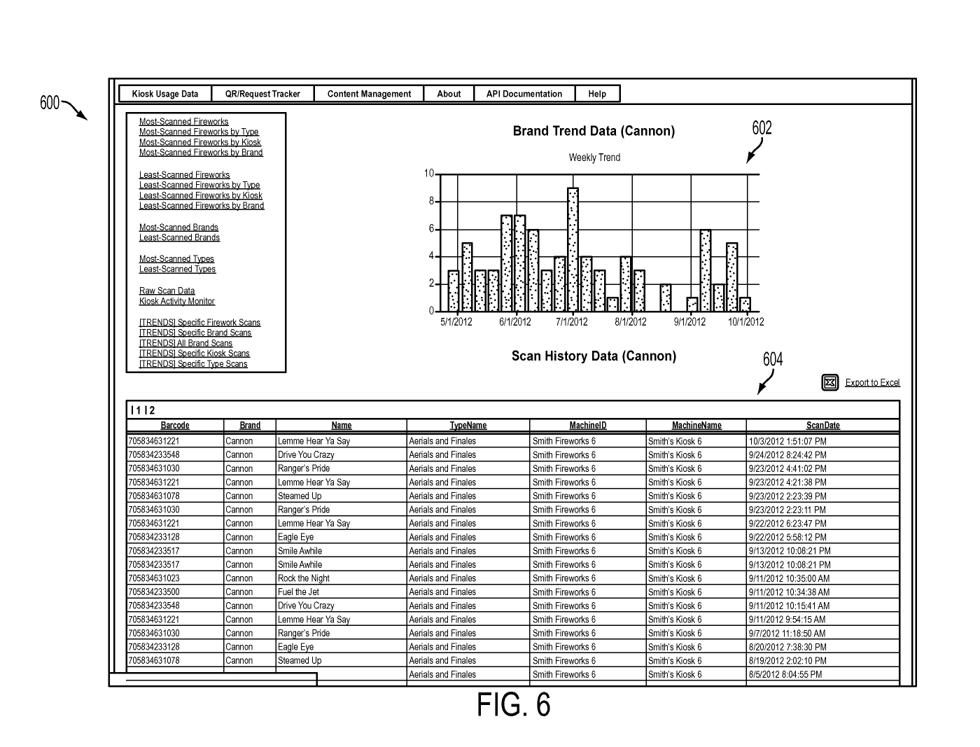

Exemplary merchant interfaces for a particular embodiment of a Firework Information System are shown in FIGS. 5 and 6. These figures represent interfaces that may be displayed, for example, on tablet computers, desktop computers, laptops, handheld devices such as smart phones, and other similar devices. These interfaces show what a merchant, firework distributer, firework manufacturer, or other user may experience, for example, when accessing the system.

FIG. 5 shows a screen display of brand trend data 500 that a merchant, firework distributer, firework manufacturer, or other user interested in firework information system usage data may utilize to view data on usage of the firework information system (e.g., the number of times that information about fireworks of various brands has been requested). It should be understood that this brand trend data may be limited to information requests (e.g., scans) for a particular kiosk at a particular retail location, for all kiosks at a particular retail location, or for all users of the firework information system (e.g., including mobile application users). The brand trend data 500 in the embodiment shown in this figure includes graphs 502, 504 of both number of scans and total scans of various firework brands. The display also includes links 506 to other data such as information about most scanned fireworks, least scanned fireworks, trends, etc. This information may be utilized by firework companies as well as retailers to track interest in various firework types, etc. For example, a particular brand may utilize this brand trend data to determine the effectiveness of a sale on all of their fireworks (e.g., to determine whether offering their fireworks at a reduced price increases interest and to what extent).

FIG. 6 shows a scanning data display 600 that includes brand trend data as a graph 602 for a particular firework brand (e.g., Cannon). In the embodiment shown in this figure, the graph 602 breaks down total scans by week. In other embodiments, the system may display brand trend data based on any other suitable time frame. In the embodiment shown in this figure, the scanning data display 600 further includes scan history data 604, which includes information about every scan received by the system (e.g., which may be stored in a data log on a data store associated with the system). This information may include, for example, the UPC code of the firework scanned, a brand of the firework, a name of the firework, a type of the firework, a machine from which the scan (e.g., the request for information) originated and a date and time of the scan.

### Alternative Embodiments

Various embodiments of a firework information system may have features that are similar to or in addition to features described above. For example, in various embodiments, the system may be configured to allow users to enter information associated with the one or more fireworks for which the user has requested information. This user-provided information may include, for example, user reviews in the form of ratings or comments, videos or images that the user has taken of the particular firework, or any other suitable information that the user may provide about the firework, their experience with the firework, etc. In particular embodiments, the system may be configured to associate the user-provided information with the firework for which it was provided and display that information to subsequent users who request information about the firework.

In other embodiments, the system may be configured to allow users to create favorite lists of the users' favorite fireworks that the user may be able to access from any device suitable for accessing the system (e.g., a mobile device, or a firework kiosk as described above).

### CONCLUSION

Many modifications and other embodiments of the invention will come to mind to one skilled in the art to which this invention pertains having the benefits of the teachings presented in the foregoing descriptions and the associated drawings. For example, as will be understood by one skilled in the relevant field in life of this disclosure, the invention may take form in a variety of different mechanical and operational configurations. Therefore, it is to be understood that the invention is not to be limited to the specific embodiments disclosed and that modifications and other embodiments are intended to be included within the scope of the appended exemplary concepts. Although specific terms are employed herein, they are used in a generic and descriptive sense only and not for the purposes of limitation.

What is claimed is:

1. A computer system comprising at least one processor, wherein the computer system is configured for:
reading one or more machine-readable indicia associated with one or more fireworks;
at least partially in response to reading the one or more machine-readable indicia, retrieving, from computer memory, information associated with the one or more fireworks, the information comprising one or more video images of the one or more fireworks detonating; and
displaying the information to a user.

2. The computer system of claim 1, wherein the computer system is configured for automatically displaying the information to the user in response to reading the one or more machine-readable indicia.

3. The computer system of claim 1, wherein the one or more machine-readable indicia comprise a barcode on the packaging of a firework product.

4. The computer system of claim 3, wherein the barcode comprises a UPC code associated with the one or more fireworks.

5. The computer system of claim 4, wherein the information comprises information selected from a group consisting of:
a brand of the one or more fireworks;
a type of the one or more fireworks;
one or more user reviews associated with the one or more fireworks;
a description of the one or more fireworks; and
one or more images of the one or more fireworks.

6. The computer system of claim 4, wherein the computer system is further configured for:
identifying a particular firework that is similar to the one or more fireworks; and
displaying the name of the particular firework to the user.

7. The computer system of claim 4, wherein the computer system is further configured for:
retrieving a video of the particular firework being detonated; and
displaying the video to the user.

8. The computer system of claim 1, wherein the computer system is further configured for:
determining model popularity information that reflects a number of times that the system has been used to read a machine-readable indicia associated with a particular model of firework; and
communicating the model popularity information to a manufacturer of the model of firework.

9. A computer system comprising at least one processor, wherein the computer system is configured for:
receiving, from a user, a UPC code associated with at least one firework; and
in response to receiving the UPC code, displaying, to the user, at least one image of the at least one firework as it detonates.

10. The computer system of claim 9, wherein the at least one image comprises a video of the at least one firework detonating.

11. The computer system of claim 10, wherein the system is configured for:
in response to receiving the UPC code, displaying, to the user, information selected from a group consisting of:
a model of the at least one firework;
a noise level of the at least one firework;
a determined safety of the at least one firework;
an altitude at which the at least one firework typically detonates;
a color of the at least one firework when it detonates;
one or more effects associated with the at least one firework when it detonates; and
a general type of the at least one firework.

12. The computer system of claim 11, wherein the computer system is further configured for:
identifying a particular firework that is similar to the at least one firework; and
playing, for the user, a video image of the particular firework detonating.

13. The computer system of claim 9, wherein:
the computer system comprises a mobile device;
the step of receiving the UPC code associated with the at least one firework comprises:
receiving, from the mobile device, an image of at least a portion of packaging associated with the at least one firework;
identifying one or more machine readable indicia in the image; and
using the machine-readable indicia to determine the UPC code.

14. The computer system of claim 9, wherein the step of receiving the UPC code associated with the at least one firework comprises:
receiving an image of at least a portion of packaging associated with the at least one firework;
identifying one or more machine readable indicia in the image; and
using the machine-readable indicia to determine the UPC code.

15. The computer system of claim 14, wherein the machine-readable indicia comprises a barcode.

16. The computer system of claim 15, wherein the barcode is a matrix bar code.

17. The computer system of claim 9, wherein the step of receiving the UPC code associated with the at least one firework comprises receiving data regarding the UPC code from a bar code scanner.

18. A computer-implemented method of displaying firework information to a user, the method comprising:
facilitating the reading of a barcode representing a UPC code associated with a particular firework;
after facilitating the reading of the barcode, determining, by a computer processor, the UPC code;
using, by a computer processor, the UPC code to access video of the particular firework detonating; and
displaying the video to the user on a computer display.

19. The method of claim 18, further comprising:
using, by a computer processor, the UPC code to access other information regarding the particular firework; and
displaying the other information to the user on a computer display, wherein the other information comprises information selected from a group consisting of:
a brand of the particular firework;
a type of the particular firework;
one or more user reviews associated with the particular firework; and
a description of the particular firework.

20. The method of claim 19, further comprising:
creating at least one entry in a data store, the at least one entry comprising:
a model of the particular firework; and
a date on which the UPC code was read.

21. A computer-readable medium storing computer-executable instructions for:
facilitating the reading of a barcode representing a UPC code associated with a particular firework;
after facilitating the reading of the barcode, determining the UPC code;
after determining the UPC code, accessing video of the particular firework detonating; and
displaying the video to the user on a computer display.

22. The computer-readable medium of claim 21, wherein the step of displaying the video to the user is done substantially immediately after the system determines the UPC code.
